(19) United States
(12) Patent Application Publication
(10) Pub. No.: US 2006/0011723 A1
(43) Pub. Date: Jan. 19, 2006

(54) Modularized card reader

(76) Inventor: Ming-Hsiang Yeh, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 10/890,097

(22) Filed: Jul. 14, 2004

(51) Int. Cl. G06K 7/06

(52) U.S. Cl. 235/441

(57) ABSTRACT

A modularized card reader is disclosed. The modularized card reader comprises a base and several card-reading units, wherein a memory card receiving opening and a transmission interface are disposed respectively on the base and the card-reading units for assembling and stacking thereof by using an assembly device on the transmission interface so as to form a selective type all-in-one card reader. Therefore, the users can gather up the same type or the different types of small capacity memory cards to form a lager capacity memory card according to the desired amount or type of their practical requirement. Thus, the older memory card will not be discarded any more and can be used persistently. It complies with economic benefits and environmental protection. Moreover, the modularized card reader complied with the future development can be used persistently, and therefore provided with superior utilization.

### FIELD OF THE INVENTION

The present invention relates to a modularized card reader, and more particularly, to gathering and stacking up the same type or different types of memory cards for extensively using thereof according to users' requirement.

### BACKGROUND OF THE INVENTION

With the progress of the technology, requirement for data storage is becoming increasingly common. There are more and more various kinds of memory cards, which have continuously increasing of memory capacity, e.g. 8M˜256M˜2M. The memory card is weeded through the old unceasingly. It is a pity that the providing with a high capacity memory card will result in the old one that has smaller capacity be discarded and not be used any more. It is wasteful, and not complied with environmental protection. Moreover, duplicated money must be spent for buying the memory card. It is indeed not complied with economic benefits.

In addition, a conventional all-in-one card reader is disclosed to read different types of memory card, for example, SD, MMC, xD, MS, SM, CF, etc. This kind of card reader includes several aforementioned card-reading slots disposed in one machine body. Although using of this card reader is convenient, it is not so practical for use. Sometimes users may merely want to utilize two or three of these card-reading slots, but they have no choice. They have to spend more money on the other unnecessary equipments in order to have these two or three card-reading slots. There is still a problem that if a new type of memory card is provided or the card-reading type of the previous card reader is not enough for the memory card, they have to buy new one. It's wasteful, and not complied with environmental protection. Consequently, the conventional card reader has no selectiveness and cannot be extended for using. It is still not complied with users' requirement for practical utilization.

### SUMMARY OF THE INVENTION

One aspect of the present invention is to provide a modularized card reader that is able to stack several small capacity memory cards for jointly using according to the users' requirement so that these memory cards with small capacity can be used persistently to comply with economic benefits and environmental protection.

Another aspect of the present invention is to provide a modularized card reader in which the memory cards are stacked to enable the users to select the type and amount of card-reading units. Moreover, the modularized card reader responds readily to the future development to be extended persistently, and therefore provided with superior utilization and economic benefit.

According to the aforementioned aspect of the present invention, there is provided with a modularized card reader, which comprises a base and a plurality of card-reading units, wherein at least one memory card receiving opening and a transmission interface are disposed on the base that has an assembly surface. The card-reading units and the base are assembled by an assembly device disposed on the assembly surface for stacking up one another. Each card-reading unit has assembly surfaces on which assembly devices are disposed, thereby stacking and assembling this card-reading unit, the base, and other card-reading unit one another by these assembly devices, wherein a transmission interface is disposed respectively on the assembly surfaces of the each card-reading unit for connecting to the transmission interface on the base or on the other card-reading unit to transmit data stored in the memory card to the base, and for further connecting to equipment such as computer to read data stored in the memory card.

Therefore, the users are enabled to buy the desired amount or type of memory card to gather up the same type or the different types of small capacity memory cards for being jointly used as a lager capacity memory card according to their practical requirement. Thus, the older memory card will not be discarded any more and can be used persistently. It complies with economic benefits and environmental protection. Moreover, the modularized card reader responds readily to the future development to be used persistently, and therefore provided with superior utilization and economic benefits.

The aforementioned aspects and advantages of the present invention will be readily clarified in the hereafter description of examples of preferred embodiments of the present invention, in reference with the enclosed drawings.

The present invention intends to cover all alternatives and arrangements of these alternatives. Nevertheless, the selected preferred embodiment is described in the specification and illustrated in the accompanying drawings.

### BRIEF DESCRIPTION OF THE DRAWINGS

FIG. 1 is an outward appearance diagram showing an assemblage of the first preferred embodiment in accordance with the present invention.

FIG. 2 is a schematic expansion view showing card-reading units of the first preferred embodiment in accordance with the present invention.

FIG. 3 is a schematic, cross-sectional view showing the first preferred embodiment in accordance with the present invention.

FIG. 4 is a schematic diagram showing the second preferred embodiment in accordance with the present invention.

FIG. 5 is a schematic diagram showing the third preferred embodiment with an expansion slot type in accordance with the present invention.

FIG. 6 is a schematic diagram showing the fourth preferred embodiment with an expansion slot type in accordance with the present invention.

### DETAILED DESCRIPTION OF THE PREFERRED EMBODIMENT

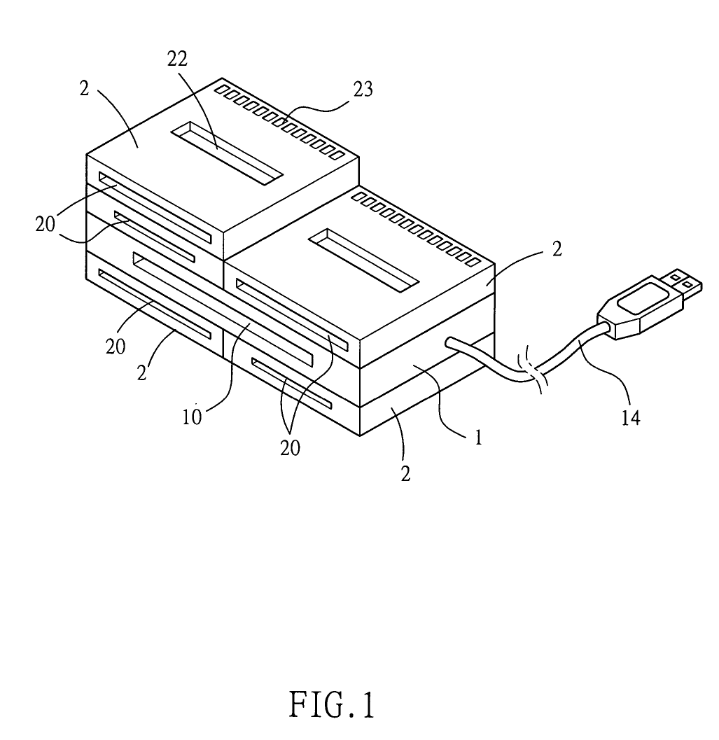

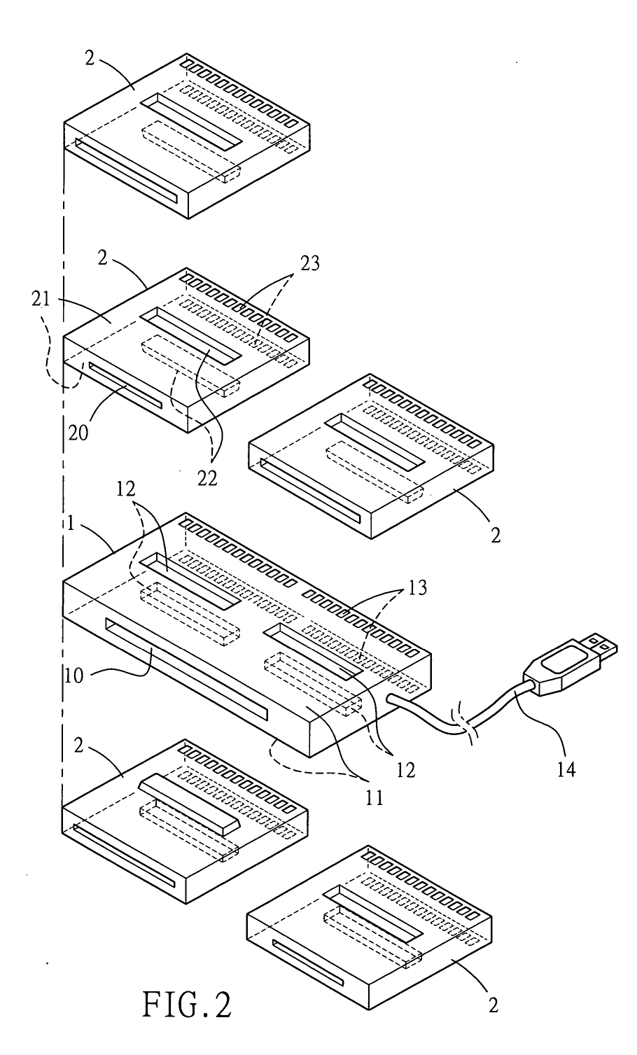

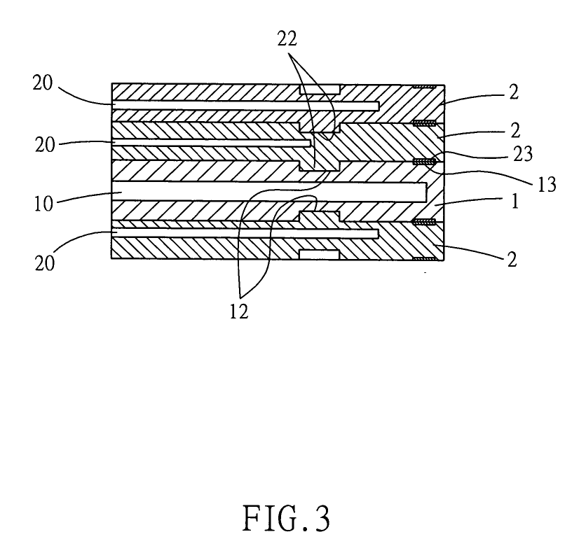

Please refer to FIG. 1, FIG. 2, and FIG. 3, which illustrate an outward appearance of an assemblage, a schematic expansion view and a schematic, cross-sectional view of card-reading units of the first preferred embodiment of the present invention. The first preferred embodiment comprises a base 1 and card-reading units 2 that are stacked and connected to each other, and can be assembled to the base 1 to form a selective type all-in-one card reader.

The base 1 is a card reader for a flash memory card, wherein a memory card receiving opening 10 is located in the front terminal of base 1 for receiving the memory card to read data stored therein. The bottom surface or the top surface of the base forms an assembly surface 11, which comprises at least one assembly device 12 disposed thereon. In this preferred embodiment, the assembly device 12 is a recessed slot. There is a transmission interface 13 disposed on the assembly surface 11 as an interface of data transmission between the card-reading units 2 and the base 1, wherein the transmission interface 13 can be electro-conductive pins or a connector. A connection apparatus 14 is disposed on the base 1 for connecting to equipment, such as computer. The connection apparatus 14 is an USB connection line.

These card-reading units 2 can be stacked to couple to the assembly surface 11 on the top surface or the bottom surface of the base 1 to form the combinatorial type all-in-one card reader. Each card-reading unit 2 comprises a memory card receiving opening 20 located on the front terminal of a housing for receiving the memory card to read data stored therein. These card-reading units 2 can be same type or different types of receiving openings. The top surface and the bottom surface of each card-reading unit 2 are assembly surfaces 21, each of which includes an assembly device 22 disposed thereon. The assembly device 22 is an outstanding plug while it is disposed on the bottom surface, and a recessed slot while on the top surface. The outstanding plug on the bottom surface can be coupled to the assembly device 12 of the base 1 to stack the card-reading unit 2 on the base 1, and the recessed slot on the top surface can receive an outstanding assembly device 22 of the other card-reading unit 2 above itself to assemble numerous card-reading units 2 for extension. Transmission interfaces 23 are disposed on the bottom assembly surface 21 and the top assembly surface 21 of the card-reading unit 2 for respectively connecting to the transmission interface 13 of the base 1 and other card-reading unit 2, thereby transmitting the data stored in the memory card of the individual card-reading unit 2 to the base 1, and further to equipment such as computer through a connection apparatus 14. The aforementioned transmission interface 13 can be in the form of electro-conductive contacts or a connector. This transmission interface 13 can be USB interface, IEEE1394, or the like.

The receiving openings on the base 1 and these card-reading units 2 can be any type of memory card, for example, SD, MMC, MS, SM, xD, CF, MD, etc. The users can buy desired amount and type of the memory card according to their needs, and assemble the assembly devices 12 and 22 by themselves for using. Besides, these can be stacked and assembled to have various appearances according to personal fondness. For example, the base 1 is a CF card type, and collocated with a SD or MMC card type of card-reading unit 2. In another way, both the base 1 and the card-reading unit 2 have the same memory card type. Thus, numerous memory cards with small capacity are gathered up to be jointly used as a card-reading apparatus with larger capacity. They can be kept in use and will not be discarded any more. Thus, it is thriftily and economically, and complied with environmental protection. The users can perform assembling and extending by using a modularized stacking way according to practical requirement. It is able to proceed with the extension if a new type of commercial memory card is available, thereby providing the users with superior utilization and economy-conformable benefits.

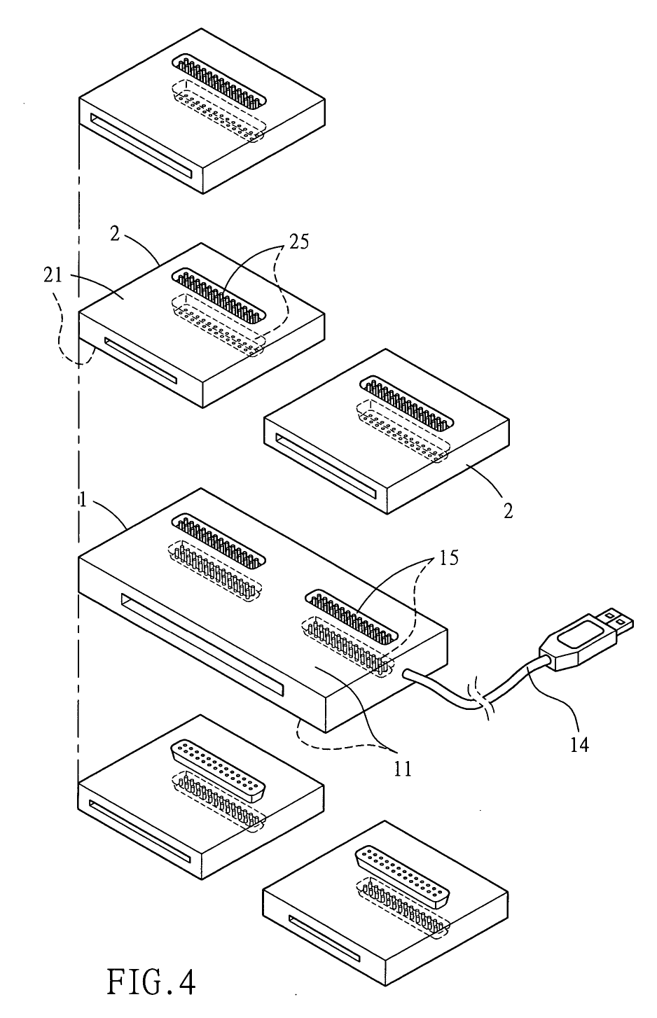

Please refer to FIG. 4, which show a schematic diagram of the second preferred embodiment in accordance with the present invention, wherein connectors 15 and 25 are disposed respectively on the assembly surface 21 of the card-reading units 2 and the assembly surface 1 of the base 1. The connectors 15 and 25 are connected to each other in male/female relationship to form an integration of the base 1 and the card-reading units 2 by stacking and assembling thereof. Data stored in various memory cards can be transmitted to the base 1 through these connectors 15 and 25, and further to equipment such as computer through the connection apparatus 14.

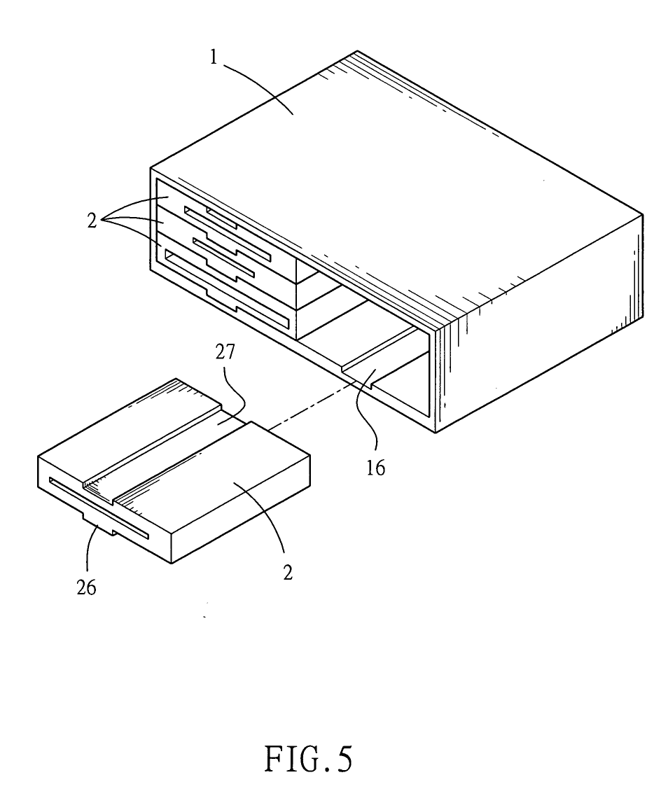

Please refer to FIG. 5, which illustrates that the modularized stack assembly of the present invention is suitable for a card reader in expansion slot type. This base 1 is a disk cassette complied with 3.5 inches or 5.25 inches specification. Several card-reading units 2 are inserted into the base 1 from its front side to be stacked therein. The base 1 can be disposed in an expansion slot of a personal computer host or an industrial computer case that is complied with the same specification to provide with the function of reading data stored in the memory card. The card-reading units 2 and the base 1 are assembled by forming the sliding trench 16 sunk into the inner bottom of the base 1 and disposing an outstanding sliding track 26 and a sunken sliding trench 27 respectively on the bottom and the top of the card-reading unit 2. The card-reading unit 2 is inserted into the sliding trench 16 from the front side of the base 1. By way of this method, other card-reading unit 2 can be upwardly stacked inside the base 1.

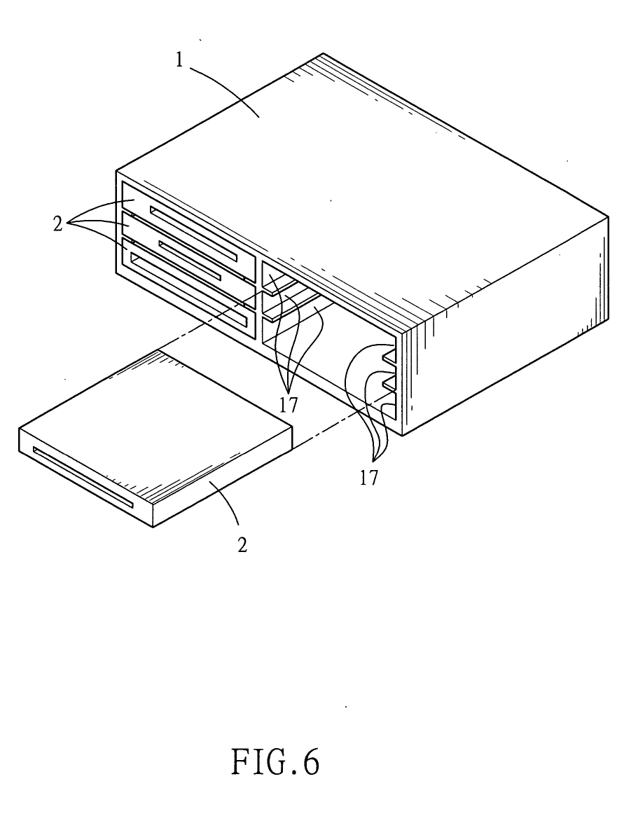

Please refer to FIG. 6, the base 1 is a disk cassette complied with 3.5 inches or 5.25 inches specification. Several card-reading units 2 are inserted into the base 1 from the front side thereof to be stacked therein. Slots 17 are disposed on the inner sidewall of the base 1, and the card-reading units 2 are inserted into these slots 17 from the front side of the base 1 to be stacked therein, thus the users can perform assembling by himself according to the desired amount and type.

Moreover, the present invention is able to gather memory cards with small capacity to form a larger memory block, for example, drive D or drive E, to facilitate the use.

Furthermore, the connection apparatus 14 of the present invention can be a wireless transmission apparatus, for example, bluetooth wireless communication, infrared ray, WiFi, IEEE802.11, etc., to exchange data with the computer equipment through a wireless way.

Therefore, as is understood by a person skilled in the art, the present invention achieves the aforementioned purpose according to the above description and satisfies requirements of patent law. The application for a patent is therefore submitted.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

1-13. (canceled)

14. A modular card reader for a computer comprising:
a) a base having a connection apparatus electrically connecting the base to the computer;
b) an assembly device; and
c) a plurality of card reading units, each card reading unit of the plurality of card reading units having a memory card receiving opening and being removably connected to at least one component selected from a group consisting of the base and an adjacent card reading unit of the plurality of card reading units by the assembly device, at least one of the plurality of card reading units is removably connected by the assembly device to the base.

15. The modular card reader according to claim 14, wherein the base having a plurality of base transmission interfaces located on a top and a bottom thereof, each card reading unit of the plurality of card reading units having a card reader transmission interface located on a top and a bottom thereof, at least one card reader transmission interface of each of the plurality of card reading units is connected to a transmission interface selected from a group consisting of one of the plurality of base transmission interfaces and one card reader transmission interface of one adjacent card reading unit, one card reader transmission interface of at least one of the plurality of card reading units is connected to one of the plurality of base transmission interfaces.

16. The modular card reader according to claim 14, wherein the assembly device having:
a) a plurality of base recessed slots located on a top and a bottom of the base;
b) a plurality of card reader recessed slots, one card reader recessed slot of the plurality of card reader recessed slots is located on a first surface of each card reading unit of the plurality of card reading units; and
c) a plurality of protruding plugs, one protruding plug of the plurality of protruding plugs is located on a second surface of each card reading unit of the plurality of card reading units, the protruding plug of each of the plurality of card reading units is inserted into a recessed slot selected from a group consisting of one of the plurality of base recessed slots and the card reader recessed slot of one adjacent card reading unit, the protruding plug of at least one of the plurality of card reading units is inserted into one of the plurality of base recessed slots.

17. The modular card reader according to claim 14, wherein the assembly device having:
a) a plurality of base connectors located on a top and a bottom of the base; and
b) a plurality of card reader connectors, one card reader connector of the plurality of card reader connectors is located on each of a first surface and a second surface of each card reading unit of the plurality of card reading units, at least one card reader connector of each of the plurality of card reading units is connected to a connector selected from a group consisting of one of the plurality of base connectors and the card reader connector of one adjacent card reading unit, the connector of at least one of the plurality of card reading units is connected to one of the plurality of base connectors.

18. The modular card reader according to claim 14, wherein the base is a disk cassette having one of a 3.5 inch specification and a 5.25 inch specification, the plurality of card reading units are inserted into a front of the disk cassette.

19. The modular card reader according to claim 18, wherein the assembly device having:
a) at least one sunken base sliding trench located on a bottom of an interior of the base;
b) a protruding sliding track located on a bottom of each of the plurality of card reading units; and
c) a plurality of sunken sliding tracks, one sunken sliding track of the plurality of sunken sliding tracks is located on a top each of the plurality of card reading units, the protruding sliding track of each of the plurality of card reading units is inserted into a sunken track selected from a group consisting of one of the at least one sunken base sliding trench and one of the plurality of sunken sliding tracks, the protruding sliding track of at least one of the plurality of card reading units is inserted into one of the at least one sunken base sliding trench of the base.

20. The modular card reader according to claim 18, wherein the assembly device includes a plurality of slots located in the base, each of the plurality of card reading units being inserted into one of the plurality of slots.
